(19) United States
(12) Patent Application Publication
(10) Pub. No.: US 2009/0024689 A1
(43) Pub. Date: Jan. 22, 2009

(54) INTERFACE DEVICE FOR SEMICONDUCTOR EQUIPMENT AND MONITORING SYSTEM USING IT

(75) Inventors: Woo Sung Kim, Chungcheongnam-do (KR); In Su Hwang, Chungcheongnam-do (KR); Yong Muk Lim, Chungcheongnam-do (KR)

Correspondence Address: LARSON AND LARSON, 11199 69TH STREET NORTH, LARGO, FL, 33773, US

(73) Assignee: HOSEO UNIVERSITY ACADEMIC COOPERATION FOUNDATION, Chungcheongnam-do (KR)

(21) Appl. No.: 11/965,562

(22) Filed: Dec. 27, 2007

(30) Foreign Application Priority Data
Jul. 20, 2007 (KR) 10-2007-0072627

(51) Int. Cl. G06F 15/16

(52) U.S. Cl. 709/202

(57) ABSTRACT

An interface device for semiconductor equipment which converts messages of semiconductor equipment received and transmitted via different protocols to integral XML (extensible Markup Language) message format, and the monitoring system using same is capable of distributed or integral message monitoring of the semiconductor equipment. The monitoring system comprising an interface device for semiconductor equipment capable of converting messages of semiconductor equipment received and transmitted via different protocols to integral XML message format, and classifying the message converted to XML format based on message characteristic. A monitoring server provided with the XML messages classified and outputted by the interface device for semiconductor equipment to perform monitoring for each message characteristic, such that an integrated monitoring or a distributed monitoring for each message characteristic relative to the messages outputted from multiple semiconductor equipment can be made possible on the web portals.

### BACKGROUND OF THE INVENTION

1. Field of the Invention

The following description relates generally to an Interface device for Semiconductor Equipment and Monitoring System Using It.

2. Description of the Prior Art

It is an essential work to collect all the status data on demand related to production in the semiconductor manufacturing process. Analysis of the collected data associated with the semiconductor manufacturing process may be utilized for production rate of semiconductor equipment, fault diagnosis, process control and removal of estimated fault element, which may contribute to manufacturing efficiency improvement in the long run.

Semiconductor industries can have dozens or even hundreds of tools, each of which is called upon periodically to perform part of a process as dictated by the selected process. The semiconductor industries therefore are very equipment-intensive, requiring many types of tools or equipment to perform the manufacturing processes. In order to effectively collect the status data generate from multiple equipments, it is essential to provide a communication protocol standardized between the equipment and computers. Concomitant with this requirement, a standardized protocol such as the SECSs (Semiconductor Equipment Communication Standards) was defined. The SECS protocol is a widely used international consensus-based standard produced by SEMI (Semiconductor Equipment and Materials International).

In other words, the SECS protocol is a communication protocol for supporting communication between equipments specifically designed for the semiconductor fabricating processes. The SECS protocol is a protocol or standard established by SEMI (Semiconductor Equipment and Material International) in order to efficiently achieve the communications between the semiconductor fabricating equipment. The SECS is broken down into three layers: a GEM layer (GEM (Generic Equipment Model) and Application layer) for managing the semiconductor fabricating processes; a message generating layer (SECS-II layer) for reporting the progressing status and results of each process; and a message transmitting/receiving layer (SECS-I layer) for transmitting and receiving the generated message.

The SECS-I and SCS-II define communication interface standards between the semiconductor fabricating equipments and the host. The standards describe details for physical connection, signal size, data rate, protocol logic, and the like, which are required for message (information) exchange between the equipments and the host. The information exchange is made through a serial point-to-point line.

All the messages transferred based on the SECS protocol obey one or more message transfer standards, and each of the message transfer standards is processed as one transaction. Combinations of those transactions control and manage the semiconductor fabricating processes.

In 2000, an Interface A standard was defined to obtain equipment information through a state-of-the-art object-oriented communications technology such as HTTP (Hyper Text Transfer Protocol)/SOAP (Simple Object Access Protocol).

The following SEMI standards are relevant to the present invention and are herein incorporated by reference, wherein the description of each is excerpted from its associated standard:
1. SEMI E4-0699: SEMI Equipment Communications Standard 1 Message Transfer (SECS-I) defines a communication interface suitable for the exchange of messages between semiconductor processing equipment and a host (Section 1.2, June 1999).
2. SEMI E5-0301: SEMI Equipment Communications Standard 2 Message Content (SECS-II) defines the details of the interpretation of messages exchanged between intelligent equipment and a host (Section 1.1, March 2001).
3. SEMI E37-0298: High-Speed SECS Message Services (HSMS) Generic Services. HSMS defines a communication interface suitable for the exchange of messages between computers in a semiconductor factory. HSMS is intended as an alternative to SEMI E4 (SECS-I) for applications where higher speed communication is needed or when a simple point-to-point topology is insufficient. HSMS is also intended as an alternative to SEMI E13 (SECS Message Services) for applications where TCP (Transfer Control Protocol)/IP (Internet Protocol) based network is preferred over OSI. (Sections 1.2, February 1998).

However, in actual manufacturing environment, SECS-I and HSMS are mixedly used. Even in equipment compliant with SECS-II message format, the message formats are differently defined according to equipment manufacturer to make it difficult to secure the same monitoring. The SECS-II message format is quite different from a standard data format used in web portals. This hinders the ability to build a monitoring system.

To solve these problems, SEMI defined the Interface A standard but because most of the equipment currently under operation does not support the Interface A, the semiconductor equipment utilizing the same takes lots of time in monitoring.

Semiconductor manufacturing goes through various complicated processes. Because of these cumbersome processes, the kinds of equipment used for semiconductor manufacturing processes vary and need many different types of equipment. Respective equipment is different in protocols depending on its providers, such that individually-designed monitoring servers are needed in consideration of respective equipment features. Therefore, there exist lots of problems squandering resources money-wise and personnel-wise.

Also, as the conventional semiconductor equipment monitoring system is formed as a unitary system, in which one monitoring server is connected to one specific semiconductor manufacturing equipment on one-on-one basis, the monitoring server is concentrated with a lot of loads in order to meet the requirement relative to statistical data of production capacity and manufacturing process. As a result, there arises a need of distributing the concentrated loads and simultaneously there arises another need of integral monitoring of multiple semiconductor equipment for effective monitoring of semiconductor manufacturing processes.

### SUMMARY OF THE INVENTION

An object of the instant disclosure is to provide an interface device for semiconductor equipment for converting messages of semiconductor equipment received and transferred via different protocols to integral XML (extensible Markup Language) message format, and a monitoring system using the interface device for semiconductor equipment capable of distributed or integral message monitoring of the semiconductor equipment.

In one general aspect, an interface device for semiconductor equipment comprises:
a SECS-I process module for receiving a semiconductor equipment message transferred via SECS-I protocol to analyze a header of the message and extracting data included in the message;
an HSMS process module for receiving semiconductor equipment message transferred via HSMS protocol to analyze a header of the message and extracting data included in the message;
data process module for mapping the message data extracted from the SECS-I process module and the HSMS process module to a pre-set self description element; and
an XML conversion module for converting the message data mapped to the self description element at the data process module to a message in the form of XML.

Implementations of this aspect may include one or more of the following features:
The self description element in the data process module includes a direction element that shows a classification code for classifying the message data according to a pre-set classification standard for each characteristic of the message data, and the apparatus further includes a data classification module for receiving the message converted to XML format via the XML conversion module to ascertain the direction element in the received message and classifying and processing the message according to the ascertained direction element;
The data classification module ascertains the direction element included in the message and classifies the message according to the direction element to transfer the classified message to one of a plurality of monitoring servers, or classifies the message according to the direction element to store the classified message in one of a plurality of data bases;
A monitoring system using an interface device for semiconductor equipment comprising a plurality of monitoring servers existing on web portals; and
an interface device for semiconductor equipment for receiving message transferred via different protocols from the semiconductor equipment to convert a message format of the received message to XML format and classifying the converted message in response to the message characteristic to transfer the converted message to any one monitoring server out of the plurality of monitoring servers.

Implementations of this aspect may include one or more of the following features:
The monitoring system using an interface device for semiconductor equipment further includes a plurality of databases and classifies the converted message in response to the message characteristic to transfer the converted message to any one monitoring server out of the plurality of monitoring servers.
In another general aspect, an interface device for semiconductor equipment comprises:
a SECS-I process module for receiving a semiconductor equipment message transferred via SECS-I protocol to analyze a header of the message and extracting data included in the message;
an HSMS process module for receiving semiconductor equipment message transferred via HSMS protocol to analyze the header of the message and extracting data included in the message;
a data process module for mapping the message data extracted from the SECS-I process module and the HSMS process module to a pre-set self description element;
an XML conversion module for converting the message data mapped to the self description element at the data process module to a message in the form of XML; and
a data classification module for classifying and processing the message converted in the form of XML through the XML conversion module in response to a pre-set classification standard.

The interface device for semiconductor equipment according to the instant novel concept can integrate messages of semiconductor equipment received and transferred through the SECS-I or HSMS protocol and provide the integrated messages by converting to a data format standardized in the form of XMAL. As a result, an integrated protocol can be provided to a semiconductor manufacturing process monitoring to enable an integrated monitoring in constructing a system for monitoring messages of the semiconductor equipment, whereby costs for constructing the system can be reduced, and an overall monitoring of the semiconductor manufacturing processes can be effectively performed through the integrated message monitoring.

Furthermore, besides the integrated monitoring, a distributed monitoring for each feature of the semiconductor messages may be possible to secure a stable monitoring system.

### BRIEF DESCRIPTION OF THE DRAWINGS

Hereinafter, the present invention will be described in detail based on a preferred embodiment not limiting the present invention with reference to the accompanying drawings. In some drawings, like reference numerals are used to designate like elements.

FIG. 1 is an aspect view of an exemplary implementation of an interface device for semiconductor equipment.

FIG. 2 is an aspect view of an exemplary implementation of an interface device for semiconductor equipment in a detailed configuration.

FIG. 3 is an aspect view of a message header of a message transferred via SECS-I protocol.

FIG. 4 is an aspect view of structure of a message transferred via HSMS protocol.

FIG. 5 is an aspect view of each element of self-description performing mapping in data process module illustrated in FIG. 2.

FIG. 6 is an aspect view of meaning of message with respect to each stream value of SECS-II.

FIGS. 7a and 7b are aspect views of a monitoring system using an interface device for semiconductor equipment.

### DETAILED DESCRIPTION OF THE PREFERRED EMBODIMENT

A detailed description of one or more implementations of the instant disclosure is provided below along with accompanying figures that illustrate the principles of the novel concept. The disclosure is described in connection with such implementations, but the disclosure is not limited to any implementations. The scope of the disclosure is limited only by the claims and the disclosure encompasses numerous alternatives, modifications and equivalents. For the purpose of clarity, technical material that is known in the technical fields related to the disclosure has not been described in detail so that the present novel concept is not unnecessarily obscured.

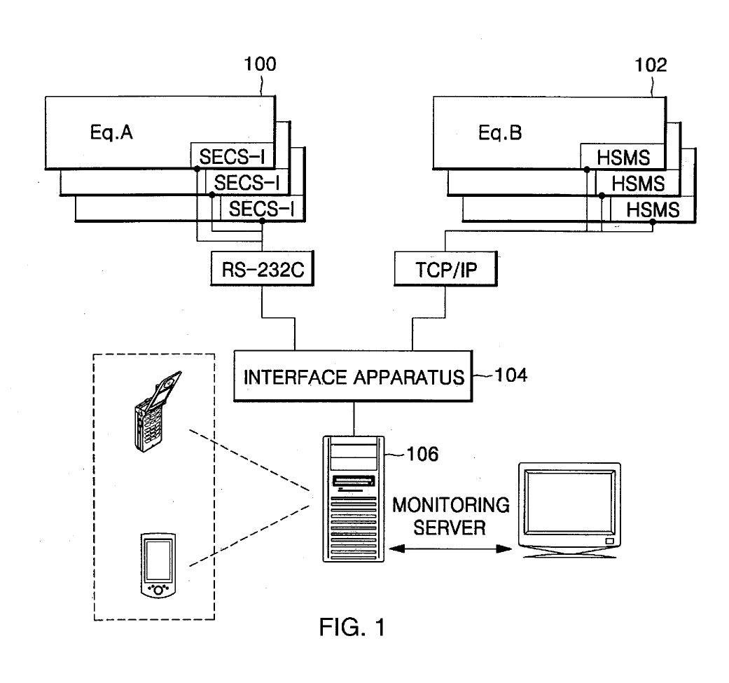

FIG. 1 is an aspect view of an exemplary implementation of an interface device for semiconductor equipment. SECS-I protocol is featured to transmit a message using RS-232C serial communication, while HSMS protocol is featured to transmit a message using TCP/IP with less restriction in communication speed and cable length than those of the SECS-I protocol.

An interface device for semiconductor equipment (104) may be connected to semiconductor equipment (100, 102) for transmitting messages via the SECS-I protocol or the HSMS protocol to integrate the types of messages that are received from the semiconductor equipment (100, 102), and functions to provide the messages that have integrated the types by a monitoring server (106) for monitoring the messages of the semiconductor equipment (100, 102). Therefore, it may be possible to perform an integrated monitoring of the messages of the semiconductor equipment (100, 102) using different protocols via the interface device for semiconductor equipment (104).

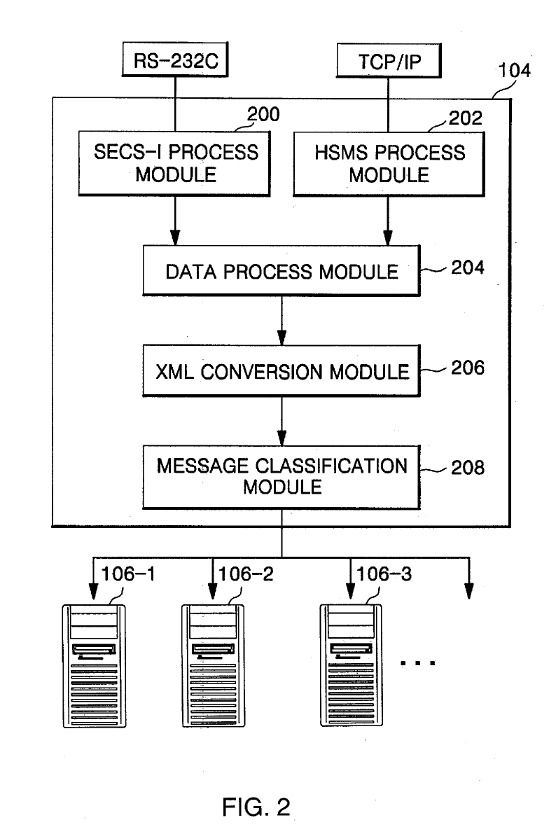

FIG. 2 is an aspect view of an exemplary implementation of an interface device for semiconductor equipment (104) in a detailed configuration thereof. Referring to FIG. 2, a detailed description of operation on the interface device for semiconductor equipment (104) performing the interface between the semiconductor equipment (100, 102) and monitoring servers (106-1, 106-2 . . . ) will be provided.

The interface device for semiconductor equipment (104) may include an SECS-I process module (200), an HSMS process module (202), a data process module (204), an XML conversion module (206), and a message classification module (208). The SECS-I process module (200) may receive messages transmitted per block unit via RS-232C, i.e., for example, a serial communication to analyze a message header and to extract data included in the message.

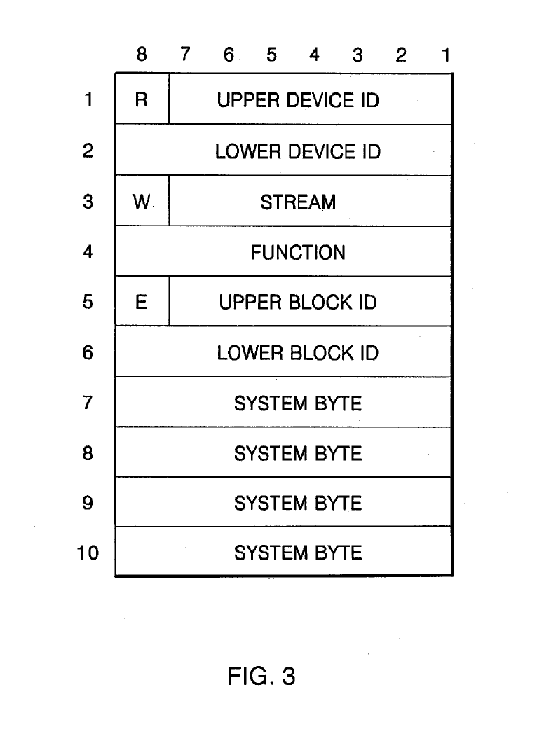

FIG. 3 is an aspect view of a message header of a message transferred via SECS-I protocol, where R defines a reverse bit indicating a message direction. A message toward the semiconductor equipment is defined as 0, while a message toward a host apparatus is set up as 1. W is a wait bit, meaning that a transmitter of a main message waits for a response. If the wait bit value is 1, it denotes that a response is awaited, while if the wait bit value is 0, it means that no response is required. Lastly, E defines an end bit, denoting that no blocks follow. If the end bit value is 1, it means that no blocks follow, and if the end bit value is 0, it denotes that other blocks follow successively. The end bit value is tested and if the last block is received, a necessary data is extracted and stored. The HSMS process module (202) may receive a message transmitted from TCP/IP to extract data included in the message.

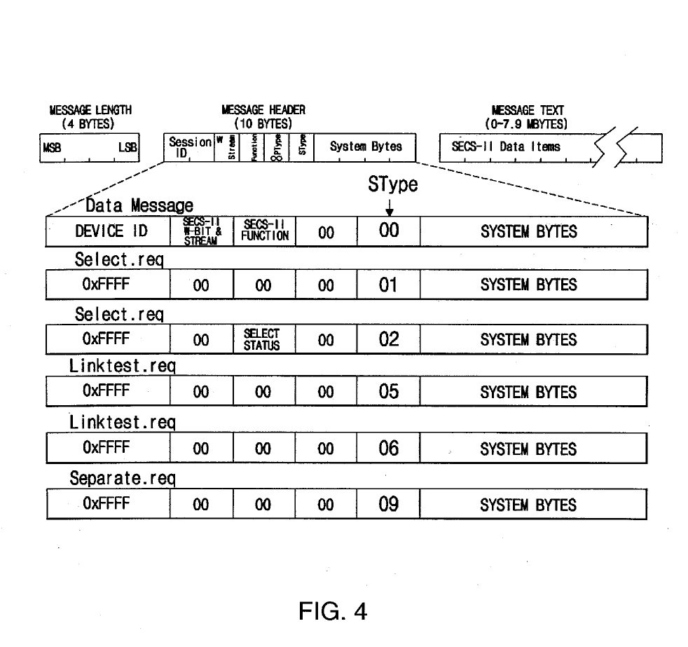

FIG. 4 is an aspect view of structure of a message transmitted via HSMS protocol, where the message transmitted via the HSMS protocol (202) may be divided into a data message and a control message. The data message denotes a message that transmits the data, and the control message means a message related to communication. The communication-related message denotes messages for initial connection set-up, connection ascertainment or connection release.

Each message illustrated in FIG. 4 may be divided according to S type. Therefore, the HSMS process module (202) may check the S type when the message is received to thereby process differently depending on whether the message is a control message or a data message. The HSMS process module (202) may extract and store necessary data, but not limited to, equipment ID (Identification), wait bit, stream and function when the received message is a data message, and when the received message is a control message, the HSMS process module may extract data and process aside from the data message via other routines. The data process module (204) may map the message data in the self-description, which is a standard so designed as to include message data extracted from the SECS-I process module (200) and the HSMS process module (202).

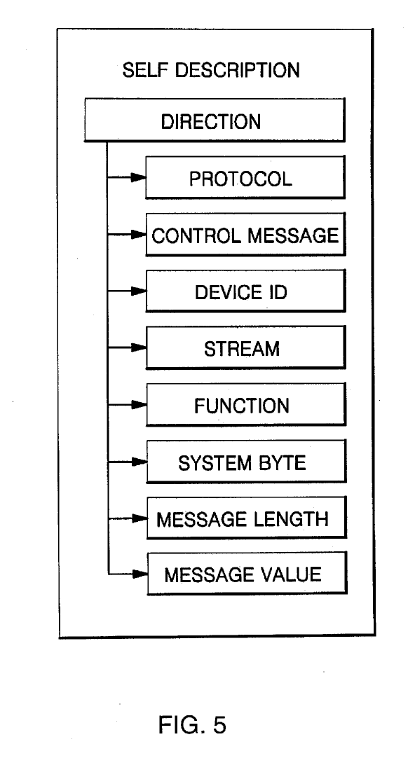

FIG. 5 is an aspect view of each element of self-description performing mapping in the data process module (204) illustrated in FIG. 2.

Now, each element will be described as below:
Direction elements are the ones indicating classification codes in which messages are classified based on classification standard pre-set per message characteristic. SECS-II messages transmitted from the semiconductor equipment may be classified based on the message characteristic by analyzing message names (for example, S5F1, S6F9, S15F1, . . . ) and message data. Consequently, the data process module (204) may grasp the message characteristic via the message data extracted from the SECS-I process module (200) and the HSMS process module (202), classify the messages in conformity with the pre-set classification standard and insert the relevant corresponding classification codes to the direction element. The main purpose of message classification is to enable a distributed monitoring for differently equipping servers classifying and monitoring the messages based on characteristics of the messages. One of the representative classification codes that can be inserted into direction elements may include identifiable information indicating a monitoring server so designated as to monitor relevant message based on each classification standard;
Protocol element is an element for recording SECS-I or HSMS which is a communication protocol used by the received message;
Control Message element is an element for recording content of message only when a message received via the HSMS protocol is a control message;
Device ID element is an element designating an ID of semiconductor equipment that has transmitted the message;
Stream element is an element for designating a SECS-II stream number;
Function element is an element for designating a SECS-II function number;
System Byte element is a byte necessary for identifying the messages;
Data Length element is an element indicative of a message length; and
Message Value element includes a list of SECS-II messages and items.

The SEMI Equipment Communications Standard Part 2 (SECS-II) defines the details of the interpretation (structure and function) of messages exchanged between intelligent equipment and a host in semiconductor manufacturing process. In other words, SECS-II defines the method of conveying information between equipment and host in the form of messages. The message names exchanged between the host and the equipment in the SECS-II are indicated in a combination of streams and functions. The stream is a classification relative to the message, while the function is a message indicating a particular behavior in the stream. All the functions used in the SECS-II are compliant with sequent set of rules of a pair of corresponding main and sub messages.

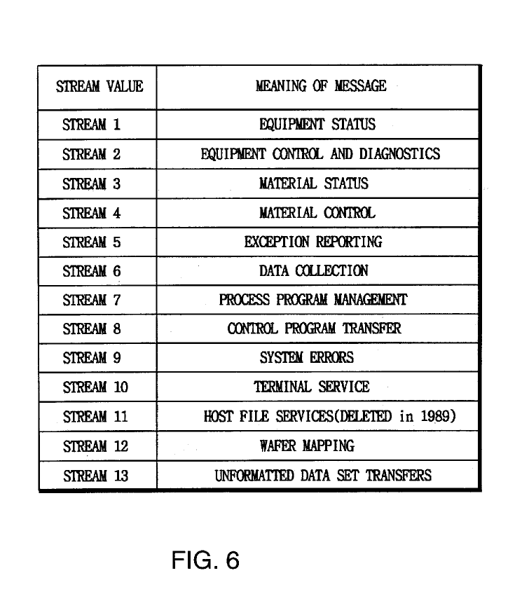

FIG. 6 is an aspect view of meaning of message with respect to each stream value of SECS-II. Although SECS-II was indeed to be fully compatible with SECS-I, a user is allowed to define new messages compliant with characteristics of each semiconductor equipment, but the user-defined messages do not allow a consistent grasp of SECS-I messages. As a result, the data process module (204) may perform a work of mapping the SECS-I process module (200) and the SECS-II message data extracted from the HSMS process module (202) to the self description.

Furthermore, the XML conversion module (206) may convert the message data mapped to the self description in XML format to standardize the message. XML is a more advanced and popular markup language for e-commerce, web portals, content services, and other information processing applications implemented on the Internet. In other words, the XML is a language similar to HTML (Hypertext Markup Language) comprising predefined elements (Tag, element) but with the additional flexibility of being able to describe data structures that can be processed directly as data by a program and can describe various formats of documents by the use of XML (extensible Stylesheet Language). As opposed to HTML, a well known advantage of XML is that it allows a designer of a document to label data elements using freely definable “tags.” The XML standard describes classes of data objects called XML documents and methods to process such XML documents. The XML document is consisted of characters, some of which form character data, and some of which form a markup language.

The XML proposed for describing the format of web documents in standardized structure is appropriate for application to semiconductor equipment fields that need unification of message formats, and information described in XML has an advantage of simplifying web-based monitoring structure.

Therefore, the interface device for semiconductor equipment (204) is so constructed as to integrate in XML structure in integrating message formats of different types transmitted from the semiconductor equipment (100, 102). Message classification module (208) may ascertain the direction elements from the messages converted to XML format through the XML conversion module (206) to classify the messages based on classification code which is a direction element, and transmit the messages to a server out of a plurality of monitoring servers existing on web portals or classify the messages to be stored in a database that stores each message per message characteristic.

Generally, the SECS-II message may be categorized into four types based on message characteristic, that is, exception, data collection, recipe management and wafer mapping, the classification of which is provided in the following Table 1.

TABLE 1

| Category | Kinds of messages |
|---|---|
| Exception | S5F1, S5F3, S5F9, S5F13, etc. |
| Data Collection | S6F9, S6F11, S6F13, etc. |
| Recipe Management | S15F1, S15F3, S15F5, S15F7, etc. |
| Wafer Mapping | S12F1, S12F3, S12F5, S12F7, S12F9, etc. |

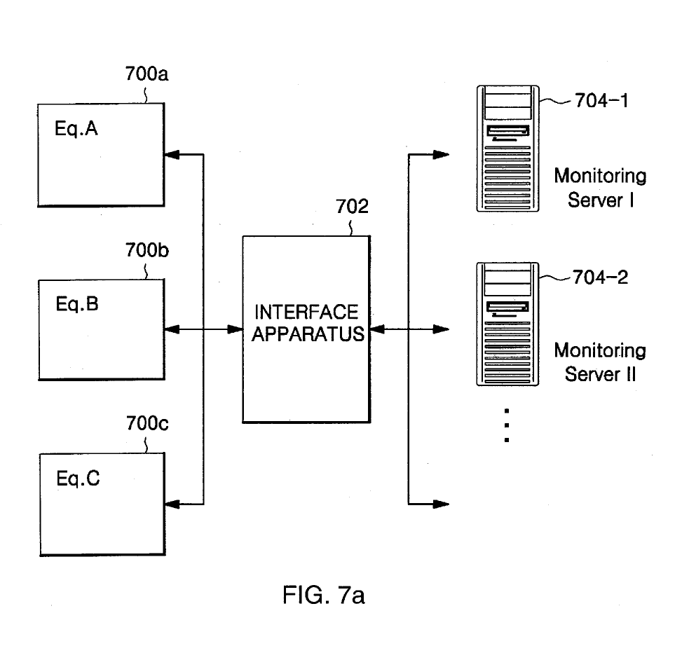

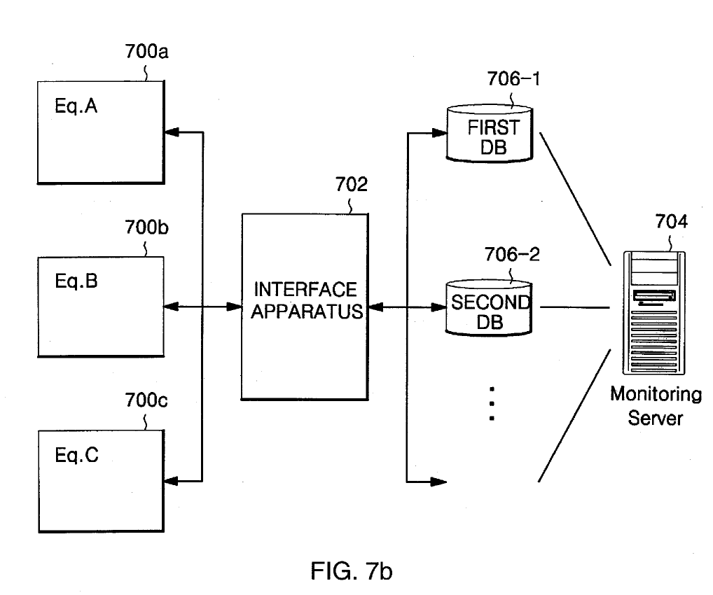

FIGS. 7a and 7b are aspect views of a monitoring system using an interface device for semiconductor equipment.

As described in the foregoing, the monitoring system performs a message monitoring using an interface device that enables an integrated management relative to messages of the semiconductor equipment that receives and transfers the messages via different protocols.

Referring to FIG. 7a, construction of the monitoring system will be described. The monitoring system may comprise: an interface device for semiconductor equipment (702) for receiving messages of semiconductor equipment (700a, 700b, 700c) to convert the message type to XML format, and classifying the messages of XML format converted in response to the message characteristic; and a plurality of monitoring servers (704-1, 704-2, . . . ) on web portals for receiving the XML messages classified and outputted from the interface device for semiconductor equipment (702) and performing the monitoring for each message characteristic.

Now, referring to FIG. 7b, the monitoring system may comprise: the interface device for semiconductor equipment (702); a plurality of databases (706-1, 706-2, . . . ) for respectively storing the XML messages classified and outputted from the interface device for semiconductor equipment (702); and an integrated monitoring server (704) for integrally managing the plurality of databases (706-1, 706-2, . . . ).

The system structure disclosed by the novel concept capable of distributive monitoring of operation of semiconductor equipment may allow monitoring an effective operation of the semiconductor equipment as various demands by customers are on the rapid increase relative to yield rate or statistical data on manufacturing processes of semiconductor equipment instead of test data of final products. Furthermore, the monitoring system has an advantage in that it has a structure of integrally monitoring messages of multiple semiconductor equipment in addition to a distributed monitoring on web portals, such that the messages can be used as data for enhancing the manufacturing efficiency through log referral/analysis of particular portion or measurement of statistical data of manufacturing processes.

The foregoing description of particular implementations of the present disclosure has been provided for the purposes of illustration and description. It is not intended to be exhaustive or to limit the disclosure to precise forms disclosed. Obviously, many modifications and variations will be apparent to practitioners skilled in the art. The implementations were chosen and described in order to best explain the principles of the novel concept and its practical application. It is intended that the scope of the instant disclosure be defined by the following claims and their equivalents.

What is claimed is:

1. An interface device for semiconductor equipment comprising:
an SECS (Semiconductor Equipment Communication Standard)-I process module for receiving a semiconductor equipment message transferred via SECS-I protocol to analyze a header of the message and extracting data included in the message;
an HSMS (High-Speed SECS Message Service) process module for receiving semiconductor equipment message transferred via HSMS protocol to analyze a header of the message and extracting data included in the message;
a data process module for mapping the message data extracted from the SECS-I process module and the HSMS process module to a pre-set self description element; and
an XML (extensible Markup Language) conversion module for converting the message data mapped to the self description element at the data process module to a message in the form of XML.

2. The interface device of claim 1, further comprising a data classification module for receiving the message converted to XML format via the XML conversion module to ascertain the direction element in the received message and classifying and processing the message according to the ascertained direction element, wherein the self description element in the data process module includes a direction element that shows a classification code for classifying the message data according to a pre-set classification standard for each characteristic of the message data.

3. The interface device of claim 2, wherein the data classification module ascertains the direction element included in the message and classifies the message according to the direction element to transfer the classified message to one of a plurality of monitoring servers, or classifies the message according to the direction element to store the classified message in one of a plurality of data bases.

4. A monitoring system using an interface device for semiconductor equipment comprising:
a plurality of monitoring servers existing on web portals; and
an interface device for semiconductor equipment for receiving message transferred via different protocols from the semiconductor equipment to convert a message format of the received message to XML format and classifying the converted message in response to the message characteristic to transfer the converted message to any one monitoring server out of the plurality of monitoring servers.

5. The monitoring system of claim 4, wherein the interface device for semiconductor equipment further comprising:
a SECS-I process module for receiving a semiconductor equipment message transferred via SECS-I protocol to analyze a header of the message and extracting data included in the message;
an HSMS process module for receiving semiconductor equipment message transferred via HSMS protocol to analyze the header of the message and extracting data included in the message;
a data process module for mapping the message data extracted from the SECS-I process module and the HSMS process module to a pre-set self description element;
an XML conversion module for converting the message data mapped to the self description element at the data process module to a message in the form of XML; and
a data classification module for classifying and processing the message converted in the form of XML through the XML conversion module in response to a pre-set classification standard.

6. The monitoring system of claim 4, further comprising a plurality of databases wherein the interface device for semiconductor equipment classifies the converted message in response to the message characteristic to transfer the converted message to any one monitoring server out of the plurality of monitoring servers.

7. The monitoring system of claim 6, wherein the interface device for semiconductor equipment further comprising:
a SECS-I process module for receiving a semiconductor equipment message transferred via SECS-I protocol to analyze a header of the message and extracting data included in the message;
an HSMS process module for receiving semiconductor equipment message transferred via HSMS protocol to analyze the header of the message and extracting data included in the message;
a data process module for mapping the message data extracted from the SECS-I process module and the HSMS process module to a pre-set self description element;
an XML conversion module for converting the message data mapped to the self description element at the data process module to a message in the form of XML; and
a data classification module for classifying and processing the message converted in the form of XML through the XML conversion module in response to a pre-set classification standard.
